(19) United States
(12) Patent Application Publication
(10) Pub. No.: US 2007/0176007 A1
(43) Pub. Date: Aug. 2, 2007

(54) Variably sized mini card

(76) Inventors: Suresh C. Priya, Aurora, IL (US); Rome Jette, Lisle, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/344,578

(22) Filed: Jan. 31, 2006

(51) Int. Cl. G06K 19/06

(52) U.S. Cl. 235/492

(57) ABSTRACT

A plastic card carrier connecting a mini card is disclosed. In one embodiment, a first plastic substrate is connected to a second plastic substrate to define the carrier having edges that form a perimeter of a carrier. A plurality of slots extend through the first and second plastic substrates and interior of the perimeter of the carrier to define the mini card within the perimeter of the carrier. Further, tabs are provided between the slots to connect the mini card to the carrier. The tabs have weakened areas to allow the mini card to be disconnected from the carrier. In one embodiment, a transponder is provided in association with the mini card carrier, and the slots are provided at least partially around the transponder to define a contactless mini card.

### CROSS-REFERENCE TO RELATED APPLICATIONS

Not Applicable.

### FEDERALLY SPONSORED RESEARCH OR DEVELOPMENT

Not Applicable.

### TECHNICAL FIELD

The present invention relates generally to a mini card having a variable size, and more specifically to a plastic carrier removably supporting a mini card, such as a financial card, gift card, luggage tag, etc., wherein the mini card has a contactless electronic element therein, and a method for manufacturing the same.

### BACKGROUND OF THE INVENTION

Housings for contactless transmitters are well known in the art. Standard housings generally comprise either an injection molded component with the contactless transmitter molded into the housing, or a CR80 sized planar card having a contactless transmitter extending from a surface or laminated between outer plastic layers of the card. While such housings for contactless transmitters according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a contactless mini card having a contactless electronic element, such as a contactless transmitter, and a method for manufacturing the contactless mini card.

According to one embodiment, the mini card is substantially planar and made of plastic. One embodiment of such a mini card initially comprises a plastic carrier having a contactless electronic element within the carrier. The carrier has an aperture extending through the carrier and at least partially around the electronic element to define a mini card.

According to another embodiment, the carrier comprises a first plastic substrate connected to a second plastic substrate. The first and second plastic substrates may be laminated together. Further, in a preferred embodiment the carrier defines a CR80 size card. Generally, the edges of the first and second plastic substrates form a perimeter of the carrier, and, in a preferred embodiment, the mini card is positioned entirely within and separate from the perimeter of the carrier.

According to another embodiment, the aperture comprises a slot extending through the first and second plastic substrates and at least partially around the electronic element to define a mini card extending between a boundary of the first and second plastic substrates. The configuration of the slot can have a multitude of shapes, and thus the mini card can be variably sized to define substantially any sized mini card within the boundary of the first and second plastic substrates. In one embodiment the slots define the edges of the mini card, and the edges of the mini card are positioned entirely within and separate from the perimeter of the carrier.

According to another embodiment, tabs extend across the slot and connect the mini card to the carrier. The tabs can subsequently be broken to disconnect the mini card from the carrier. In one embodiment, the tabs have a notch therein that defines a break area for separating the mini card from the carrier.

According to another embodiment, the carrier has a plurality of slots extending through the first and second plastic substrates and around the electronic element. And, the carrier has a plurality of tabs, with a tab extending between the adjacent slots. The tabs connect the mini card to at least one of the first and second plastic substrates of the carrier. Preferably, the tabs have weakened areas to allow the mini card to be disconnected from the first and second plastic substrates.

According to another embodiment, the electronic element is a chip that transmits a radio frequency. Preferably, at least one coil is associated with the chip. The coil is formed of at least one wire winding having wire ends that contact the chip. In one embodiment, the contactless electronic element is positioned between the first and second plastic substrates. Further, in one embodiment, the electronic element is provided on an overlay.

According to another embodiment, the contactless plastic card comprises a first plastic substrate connected to a second plastic substrate to define a carrier having edges that form a perimeter of a carrier. A transponder is provided in association with the carrier, and a plurality of slots extend through the first and second plastic substrates interior of the perimeter of the carrier and at least partially around the transponder to define the mini card within the perimeter of the carrier. Tabs are also provided between the slots to connect the mini card to the carrier. The tabs have weakened areas to allow the mini card to be disconnected from the carrier.

According to another embodiment, the transponder comprises an antenna electrically connected to a chip. The transponder is housed on a substrate, and the substrate is positioned between the first and second overlays.

According to another embodiment, printing is provided on an outer surface of at least one of a first side or a second side of the mini card.

According to another embodiment, a method for manufacturing a mini card is provided. The method comprises providing a substantially planar carrier having an outside edge, and punching an aperture in the carrier to define at least a portion of the perimeter of the mini card interior of the outside edge of the carrier. The method may also comprise the steps of providing a contactless electronic component and positioning the contactless electronic component within the carrier, and punching the aperture in the carrier to define tabs separating portions of the aperture, the tabs connecting the mini card to the carrier.

According to yet another embodiment, a contactless plastic card is disclosed and comprises a first plastic substrate, a second plastic substrate connected to the first plastic substrate to define a carrier having edges that form a perimeter of the carrier, an electronic element positioned between the first and second plastic substrates, and a break line in the first and second plastic substrates and at least partially around the electronic element and within the perimeter of the carrier to define a mini card extending entirely within the perimeter of the carrier, the mini card being removable from the carrier.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of a mini card;

FIG. 2 is a perspective view of the carrier of FIG. 1 with the mini card removed;

FIG. 3 is a top plan view of the card of FIG. 1;

FIG. 4 is an exploded side cross-sectional view of the card through line 4-4 of FIG. 3;

FIG. 5 is a top plan view of another embodiment of a mini card;

FIG. 6 is a schematic flow diagram of one embodiment of a process for manufacturing a variably-sized mini card;

FIG. 7 is a partial peeled away perspective view of a sheet of mini cards prior to end manufacturing processing; and,

FIGS. 8A and 8B are different embodiments of transponders for contactless mini card embodiments.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

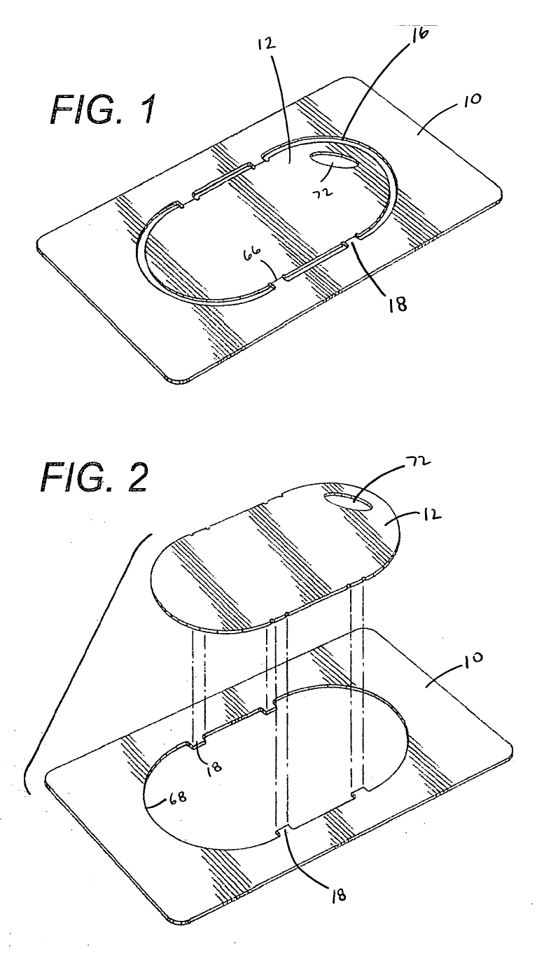

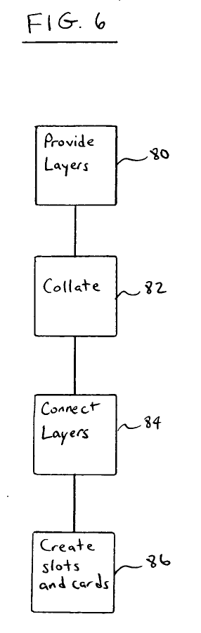

Referring now to the Figures, and specifically FIGS. 1 and 6, there are shown various embodiments of a carrier card 10 containing a removable miniature-sized card 12, also referred to as a mini card 12. Generally, the mini card 12 is a laminated plastic card, and one embodiment preferably has a contactless electronic element 14 therein. Additionally, in various embodiments the mini card 12 has a shape and size that is defined by an aperture 16 in the carrier card 10. Tabs 18 connect the mini card 12 to the card carrier 10.

In a preferred embodiment, the overall card carrier 10 has a size which meets CR80 specifications. As such, the card carrier 10 having the mini card 12 can be manufactured utilizing many standard processes and standard machinery. Further, the card carrier 10 and mini card 12 are preferably substantially planar (i.e., generally flat) and rigid (i.e., able to maintain its form and shape, but can still be flexed to a degree and return to its original shape). These meanings of planar and rigid are utilized throughout.

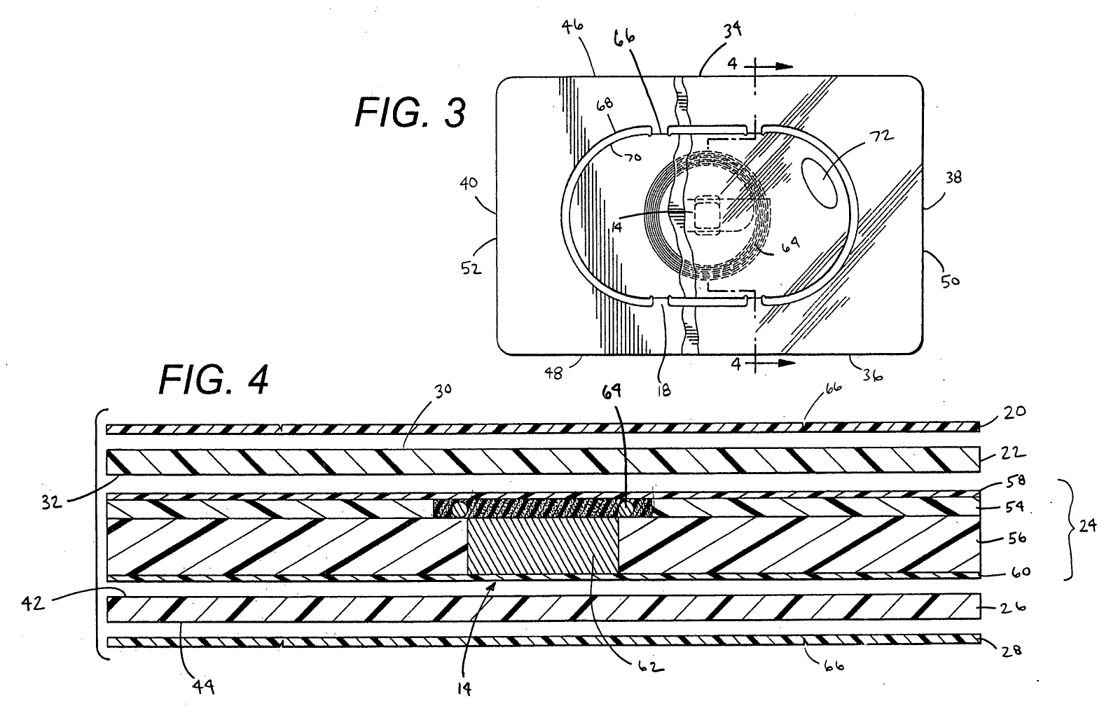

As shown in FIGS. 3, 4 and 7, the card carrier 10 as well as the mini card 12 comprises a plurality of different layers. In one embodiment, the various layers embodied in the card carrier 10 and the mini card 12 comprise a top overlay 20, a first substrate 22, an electronic element 14 preferably provided as part of an inlay 24, a second substrate 26 and a bottom overlay 28. Each of these layers is generally connected, and the electronic element 14 is preferably positioned between the first and second plastic substrates 22, 26. In another embodiment the card carrier 10 and the mini card 12 comprises a top overlay 20, a first substrate 22, a second substrate 26 and a bottom overlay 28. It is understood that card 10 and mini card 12 may comprise a fewer or greater number of layers than identified above.

The first and second substrates 22, 26 are generally made of a generally rigid and substantially planar plastic material. In a preferred embodiment, the first and second substrates 22, 26 are made of a 5 mil. solid core PVC material, however, it is understood that thinner or thicker substrates, as well as different materials, may be utilized. The material may be provided in sheet or roll form.

The first substrate 22 has an outer or first surface 30 and an inner or second surface 32 opposing the first surface 30. The first substrate 22 also has a plurality of sides or edges. In one embodiment wherein the card carrier 10 is generally rectangular, such as when it is sized to CR80 specifications, the first substrate 22 has a first side 34, a second side 36 opposing the first side 34, a third side 38 and a fourth side 40 opposing the third side 38. The sides 34, 36, 38 and 40 of the first substrate 22 define a perimeter or boundary of the first substrate 22.

Similarly, the second substrate 26 has an inner or first surface 42 and an outer or second surface 44 opposing the first surface 42. The second substrate 26 also has a plurality of sides or edges. In one embodiment wherein the card carrier 10 is generally rectangular, such as when it is sized to CR80 specifications, the second substrate 26 has a first side 46, a second side 48 opposing the first side 46, a third side 50 and a fourth side 52 opposing the third side 50. The sides 46, 48, 50 and 52 of the second substrate 26 define a perimeter thereof or boundary of the second substrate 26. Further, the sides or edges of the first and second substrates 22, 26 form the perimeter or boundary of the card carrier 10, generally defining a CR80 sized card 10.

Additionally, in a preferred embodiment the top and bottom overlays 20, 28, also referred to as over-laminating film in certain processes, are generally made of a plastic material, typically a clear or transparent plastic material, and preferably are made of clear PVC. In a preferred embodiment, the overlays 20, 28 are approximately 2 mil. thick, however, it is understood that thinner or thicker overlays, as well as different materials, may be utilized without departing from the scope of the present invention. For example, the thickness of the film for the overlays 20, 28 may be within the range of from 1 mil. to about 6 mil. The overlay material preferably has properties of being heat-sealable, durable, low permeability to oxygen, carbon dioxide and gases in general, and is a material that has strength and flexibility at both room temperature and low temperatures. The overlay material may be provided in sheet or roll form. Alternatively, the overlay may be provided in a printing or silk screen process, or any equivalent process.

In a preferred embodiment, a plurality of card carriers 10, each generally having a mini card 12 associated therewith, are manufactured simultaneously in a part of a common sheet (See FIGS. 6 and 7). Thus, the outer perimeter of each of the layers of the card carrier 10 are generally identical, because each of the respective outer sides or edges of each of the layers of the card carrier 10 are manufactured simultaneously as a unit (i.e., the first side 34 of the first substrate 22 is adjacent the first side 46 of the second substrate 26, the second side 36 of the first substrate 22 is adjacent the second side 48 of the second substrate 26, the third side 38 of the first substrate 22 is adjacent the third side 50 of the second substrate 26, and the fourth side 40 of the first substrate 22 is adjacent the fourth side 52 of the second substrate 26). Accordingly, the overall perimeter of the card carrier 10 is the same as the perimeter of several of the various layers of the card 10, including the first and second plastic substrates 22, 26.

Typically, the outer surfaces of the first and second substrates 22, 26 (i.e., the first surface 30 of the first substrate 22, and the second surface 44 of the second substrate 26) has printing thereon. The printing may be accomplished through a variety of printing processes. Various processes which may be utilized are litho printing, including using an offset litho process and/or a silkscreen process. Additionally, a flexographic process may be utilized. It is understood that additional printing processes may also be utilized. Further, a contact machine readable member, such as a magnetic strip, may be provided to the appropriate layer of the mini card 12.

As shown in FIG. 4, in a preferred embodiment, the inlay layer 24 comprises a first inlay substrate 54, a second inlay substrate 56, an electronic element 14, a top overlay 58 and a bottom overlay 60. Similarly, each of these layers is generally connected. It is understood that the inlay layer 24 may comprise a fewer or greater number of layers than identified above. For example, the inlay layer 24 may comprise an electronic element 14 on or embedded into one of the inlay substrate layers 54,56.

The electronic element 14 may perform a wide variety of functions, and take a wide variety of forms. In one embodiment, the electronic element 14 is a chip 62, such as a micro chip. One type of chip 62 is a radio frequency or RF chip. Further, in various embodiments an antenna 64, such as at least one wire coil 64 or a circuit board is associated with the chip 62. In the embodiments illustrated, a plurality of windings of coil wire 64 operate as the antenna 64 for the chip 62. In such an embodiment, the ends or some other area of the wire coil 64 contacts the chip 62. The term transponder 65 is utilized herein to define a chip 62 having an antenna 64.

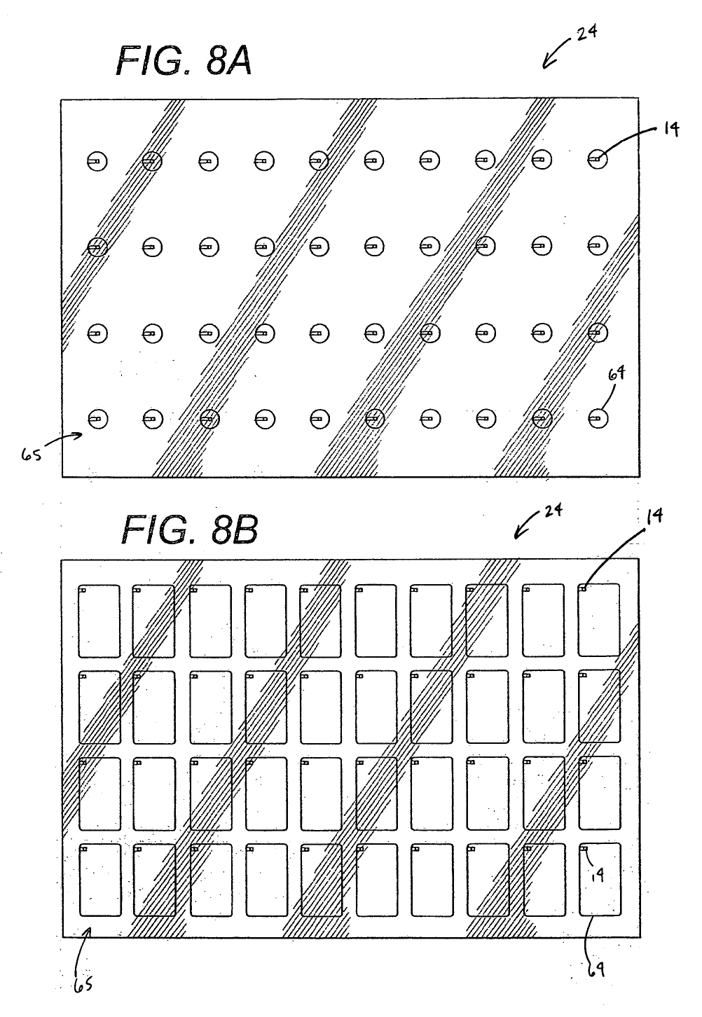

In the preferred embodiment of the inlay layer 24, as shown in FIGS. 4, 8A and 8B, the inlay layer 24 is generally made in accordance with the following process. First, the coil windings of the antenna 64 are connected to the first inlay substrate 54, and preferably, the coil windings 64 are at least partially embedded into the first inlay substrate 54. In a preferred embodiment the first inlay substrate 54 is approximately 100 microns thick, and is typically made of a plastic material, the preferred being polyvinyl chloride (PVC). Further, the coil windings 64 are preferably made of copper wire. The coil windings 64 may have a varied number and shape. As shown in FIGS. 8A and 8B, various embodiments of the coil windings 64 may be provided, such as circular and rectangular. Generally, the overall length of the windings, the size of the wire and the type of wire will affect the resonance frequency of the transponder. Different size windings are provided for different applications, and allow different size mini cards 12 to be created around the windings 64.

The chip 62 is electrically connected to the coil windings 64. An epoxy or other suitable material may be utilized to secure the coil windings 64 to the chip 62. In one embodiment the preferred chip 62 is a MCC2 Mifare chip having a thickness of approximately 240 microns. Because the chip 62 has a thickness, in order to maintain a generally even thickness to the overall inlay 24, a second inlay substrate 56 having approximately the same thickness as the chip 62, but having an aperture in the substrate 56 sized to accommodate the chip 62, is utilized. By utilizing a second inlay substrate 56 having approximately the same thickness of the chip 62, when the second inlay substrate 56 is placed on the first inlay substrate 54, the chip 62 is located in the aperture and the overall thickness of the inlay layer 24 is substantially flat. Finally, the first or top overlay 58 is positioned on the outer surface of the first inlay substrate 54, and the second or bottom overlay 60 is positioned on the outer surface of the second inlay substrate 56. Typically, each of the overlay layers 58,60 have a thickness of approximately 40 microns. Each of the layers of the inlay 24 is laminated together with an appropriate amount of heat and pressure to form the single inlay layer 24. Thus, with all of the layers laminated together the complete inlay layer 24 has an overall thickness of approximately 420 microns.

As shown in the embodiment of FIG. 1, an aperture or slot 16 is provided in the carrier card 10, preferably with tabs 18 within the slot 16, to define the mini card 12 and to connect the mini card 12 to the card carrier 10. The slots 16 may be linear, arcuate or have substantially any geometrical configuration possible for a slot. Each slot 16 generally has an outer edge 68 and an inner edge 70. Typically, the inner edge 70 of the slot 16 defines a portion of the mini card 12 adjacent thereto. The tabs 18 generally extend across the width of the slot 16, extending from the slot's inner edge 70 to its outer edge 68, to preferably connect the mini card 12 the carrier 10, but alternately to connect the mini card 12 to at least one of the first and second substrates 22, 26.

The slot 16 generally extends through the top overlay 20, through the first substrate 22, through a portion of the inlay 24 but a distance around or from the electronic element 14, and through the second substrate 26 and the bottom overlay 28. When tabs 18 are provided, the card 10 may be identified as having a plurality of adjacent slots 16 around the mini card 12 and separated by the tabs 18. Further, weakened areas, such as scores or notches 66, are provided in the tabs 18 to define a break area where a user can break the tab 18 to easily disconnect the mini card 12 from the carrier 10. The scores 66 do not extend through each of the layers of the carrier 10, but rather extend only through one or a few of the various layers of the card carrier 10. Typically, as described later herein, the slots 16 are punched through the entire thickness of the card 10 so as to minimize or eliminate warping of the carrier 10 and mini card 12.

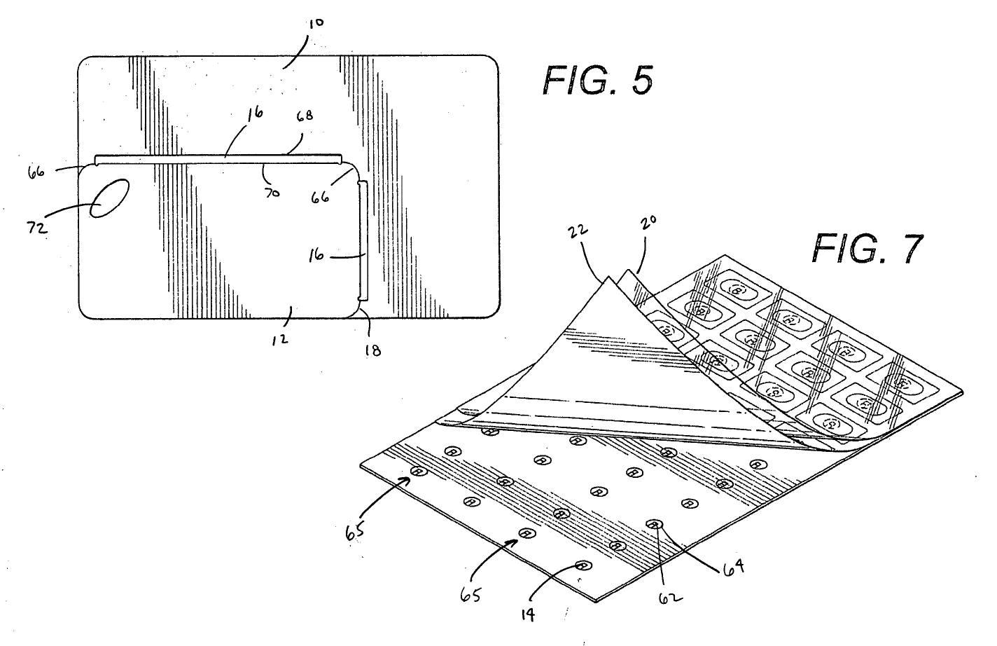

Various embodiments of the mini card 12 attached to the carrier 10 are disclosed, and it is understood that a multitude of additional embodiments and variations of the mini card 12 attached to the carrier 10 are possible. For example, because of the structures and manufacturing processes disclosed herein, it is possible to have a mini card 12 having almost any geometrical configuration and size, generally subject only to the constraints of the boundary or perimeter of the card carrier 10 and the transponder 65. In one embodiment, referring to FIG. 1, the mini card 12 is positioned entirely within and separate from any of the edges of the carrier card 10 (i.e., within the perimeter of the card carrier 10). In such an embodiment the slots 16 are provided interior of the perimeter of the carrier 10. In one embodiment, the slots 16 extend about at least 60% of the perimeter of the mini card 12. In another embodiment, referring to FIG. 5, a portion of one or more edges of the mini card 12 are not positioned entirely within and separate from any of the edges of the card carrier 10. In this embodiment, two sides of the mini card 12 are defined by the perimeter of the card carrier 10.

As shown in FIG. 1, an additional aperture 72 may be provided in the mini card 12. The aperture 72 typically extends through each of the layers of the mini card 12. The aperture 72 can be utilized as a means for attaching the mini card 12 to a key ring or other attaching device. In a preferred embodiment, the aperture 72 has an oval shape. This shape has been shown to provide superior break resistance when compared to other tested shapes.

The flow diagram of FIG. 6 schematically illustrates one series of process steps in making a contactless mini card 12. First, as provided in step 80 the appropriate layers are provided. Typically, the layers are provided in sheet format so that a plurality of carriers 10 having mini cards 12 may be manufactured generally simultaneously. For example, as shown in FIGS. 7, 8A and 8B, a typical sheet that comprises each layer will contain available space for manufacturing approximately forty (40) carriers 10 having mini cards 12. Accordingly, each sheet will contain approximately 40 cards 10 that will be created together and then cut apart from the sheet to create the individual cards 10. As explained above, in one embodiment five layers comprise the mini card 12 and carrier 10: the first layer is the first overlay 20, the second layer is the first substrate 22, the third layer contains the electronic element 14 and preferably is an inlay 24 having the electronic element 14, the fourth layer is the second substrate 26, and the fifth layer is the bottom overlay 28. As disclosed herein, however, different embodiments require different types and quantities of layers.

Typically, for the assembly step each of the layers have been pre-manufactured to their individual desired final state. For example, the inlay 24 having the electronic element has been pre-manufactured, the first and second substrates 16, 22 have been pre-printed with the appropriate printing, etc. After the desired layers are provided at step 80, the next step is generally a collation step 82 to place the layers in the appropriate order. After the layers are collated the sheets are connected in step 84. In a preferred embodiment the connection step is accomplished through a lamination process in a platen press under controlled conditions. For example, in one lamination process the layers are laminated at 340° F. at 145 PSI for approximately 16 minutes. The layers are then cooled for an additional 16 minutes at 192 PSI. It is understood that different materials and layer combinations will require different lamination process parameters.

After the layers are connected, at step 86 the connected sheets are cut into individual cards, preferably in a die cutter, to the desired card size, typically that which meets CR80 specifications. In one embodiment of step 86, the slots 16, tabs 18 and any scores 66 are also formed in the carrier cards 10. Alternatively, the slots and tabs may be formed separately. In step 88 the individual cards 10 are inspected for defects and non-conformance, and moved to the hot-stamp department. Any signature panels, holograms or other decorations, if desired, may be applied to the card 10 at that point. The finished cards are then counted and packed according to customer specifications.

Since the mini cards 12 are created within a CR80 sized carrier 10 in a preferred embodiment, the card carrier 10 having the mini card 12 can be manufactured utilizing many standard processes and standard machinery. The mini card 12 is maintained in a connected state to the carrier 10 for all post-manufacturing processing, such as inspecting, packaging and shipping. Accordingly, standard packaging techniques and components may also be utilized with this mini card 12. Generally, the mini card 12 is shipped to the end user in the connected state, and the user will break the tabs 18 at the scores 66 to remove the mini card 12 from the carrier 10 for use thereof, as shown in FIG. 2.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A contactless plastic card, comprising:
a first plastic substrate;
a second plastic substrate operably connected to the first plastic substrate;
a contactless electronic element positioned between the first and second plastic substrates; and,
a slot extending through the first and second plastic substrates and at least partially around the electronic element to define a mini card extending between a boundary of the first and second plastic substrates.

2. The contactless plastic card of claim 1, wherein the boundary of the first and second plastic substrates defines a CR80 size card.

3. The contactless plastic card of claim 1, wherein the mini card can be variably sized to define substantially any sized mini card within the boundary of the first and second plastic substrates.

4. The contactless plastic card of claim 1, wherein edges of the first and second plastic substrates form a perimeter of a carrier card, and wherein the mini card is positioned entirely within and separate from the edges of the carrier card.

5. The contactless plastic card of claim 1, wherein the slot has at least one arcuate portion.

6. The contactless plastic card of claim 1, further comprising tabs extending across the slot and connecting the mini card to the first and second plastic substrates, and wherein the tabs can be broken to disconnect the mini card from the first and second plastic substrates.

7. The contactless plastic card of claim 6, further comprising a notch in the tabs, the notch defining a break area for separating the mini card from the plastic substrates.

8. The contactless plastic card of claim 1, further comprising an aperture in the mini card.

9. The contactless plastic card of claim 1, further comprising a plurality of slots extending through the first and second plastic substrates and around the electronic element.

10. The contactless plastic card of claim 9, further comprising tabs between slots, the tabs connecting the mini card to at least one of the first and second plastic substrates, the tabs further having weakened areas to allow the mini card to be disconnected from the first and second plastic substrates.

11. The contactless plastic card of claim 1, further comprising a machine readable member on a surface of the mini card.

12. The contactless plastic card of claim 1, wherein the electronic element is a chip.

13. The contactless plastic card of claim 12, further comprising at least one coil associated with the chip.

14. The contactless plastic card of claim 13, wherein the coil is formed of at least one wire winding having portions that contact the chip.

15. A contactless plastic card, comprising:
a first plastic substrate connected to a second plastic substrate to define a carrier having edges that form a perimeter of a carrier, a plurality of slots extending through the first and second plastic substrates interior of the perimeter of the carrier and at least partially around a transponder to define a mini card within the perimeter of the carrier, and tabs between the slots to connect the mini card to the carrier, the tabs having weakened areas to allow the mini card to be disconnected from the carrier.

16. The contactless plastic card of claim 15, wherein the slots define edges of the mini card, and wherein the edges of the mini card are positioned entirely within and separate from the perimeter of the carrier.

17. The contactless plastic card of claim 15, wherein the transponder comprises an antenna electrically connected to a chip, the transponder being housed on a substrate, and the substrate positioned between the first and second substrates.

18. The contactless plastic card of claim 15, further comprising printing on an outer surface of at least one of the first and second plastic substrates.

19. A mini card, comprising:
a substantially planar plastic carrier;
a contactless electronic element within the carrier; and,
an aperture extending through the plastic carrier and at least partially around the electronic element to define a mini card.

20. The mini card of claim 19, further comprising a plurality of tabs connecting the mini card to the plastic carrier, the tabs extending through the aperture and separating areas of the aperture.

21. The mini card of claim 19, wherein the carrier comprises a first plastic substrate connected to a second plastic substrate.

22. The mini card of claim 21, wherein the first plastic substrate is not in direct contact with the second plastic substrate.

23. The mini card of claim 19, wherein the aperture extends about at least 60% of the perimeter of the mini card.

24. The mini card of claim 19, wherein the electronic element is associated with an overlay.

25. The mini card of claim 19, wherein the carrier comprises first and second plastic substrates that are laminated together.

26. The mini card of claim 19, wherein a perimeter of the mini card is distinct from any outer edge of the carrier.

27. The mini card of claim 26, wherein an edge of the aperture defines a portion of the perimeter of the mini card.

28. A transaction card comprising:
a substantially planar laminated plastic carrier having a perimeter defining a CR80 sized card, and a mini card removably connected to the carrier and being entirely positioned interior of the perimeter of the carrier.

29. The transaction card of claim 28, further comprising a contactless chip provided in the mini card.

30. A method for manufacturing a mini card, comprising the steps of:
providing a substantially planar carrier having an outside edge; and, punching an aperture in the carrier to define at least a portion of the perimeter of the mini card interior of the outside edge of the carrier.

31. The method of claim 30, further comprising the steps of providing a contactless electronic component and positioning the contactless electronic component within the carrier.

32. The method of claim 31, further comprising the steps of punching the aperture in the carrier to define tabs separating portions of the aperture, the tabs connecting the mini card to the carrier.

33. A contactless plastic card, comprising:
a first plastic substrate;
a second plastic substrate connected to the first plastic substrate to define a carrier having edges that form a perimeter of the carrier;
an electronic element positioned between the first and second plastic substrates; and,
a break line in the first and second plastic substrates and at least partially around the electronic element and within the perimeter of the carrier to define a mini card extending entirely within the perimeter of the carrier, the mini card being removable from the carrier.

34. The contactless card of claim 33, wherein the break line comprises a slot through the carrier.
